(19) United States
(12) Patent Application Publication
(10) Pub. No.: US 2019/0033117 A1
(43) Pub. Date: Jan. 31, 2019

(54) DEVICE AND METHOD FOR MEASURING COMMODITY VOLUME IN A RAIL TANK CAR

(71) Applicant: TRANSRAIL INNOVATION INC., Calgary (CA)

(72) Inventors: CHRISTOPHER WILLIAM STOBART, Calgary (CA); NICHOLAS ANDREW FORBES, Calgary (CA)

(21) Appl. No.: 16/070,163

(22) PCT Filed: Jan. 12, 2017
(86) PCT No.: PCT/CA2017/050038

§ 371 Date: Jul. 13, 2018

Related U.S. Application Data
(60) Provisional application No. 62/278,223, filed on Jan. 13, 2016.

(51) Int. Cl. G01F 23/284

(52) U.S. Cl. CPC G01F 23/284

(57) ABSTRACT

The invention relates to particular devices and methods for measuring commodity volume in a rail tank car. In accordance with an aspect of the present invention, the device can comprise a configuration so as to enable permanent or semi-permanent installation on a rail tank car while minimizing interference with other fittings and valves.

### FIELD OF THE INVENTION

The invention disclosed herein relates to particular devices and methods for measuring commodity volume in an enclosure such as a rail tank car.

### BACKGROUND OF THE INVENTION

Tank level measurement radar systems can be common in the art and across many industries. These devices can be designed to be mounted on various tanks using a wide array of antenna types and adapters. Furthermore, tank level measurement systems can be used to monitor processes such as checking level, filling, and emptying a tank in safe or hazardous locations. A market which may have been neglected due to significant regulatory and design constraints is the rail industry.

Current solutions for level measurement have included mechanical gauges, dipstick measurements, and radar. Sealed vessels such as tank cars may require devices that attach to its primary closures to undergo proof pressure testing to ensure there is no leakage. This can make installation and removal of devices costly for an end customer. Current radar systems used in rail may not be industry specific and can be temporarily installed through a valve during the trans-loading process, which can cause poor performance. Additionally, there may not be any battery powered standalone radar level measurement systems that may be tailored specifically to these rail tank cars. A radar system that permanently mounts to a tank car can require specific geometry for allowing tool access, and allow for maintaining clearance to other fittings and valves located within the crash cage.

The trans-loading process can have specific requirements for level measurement systems: it should accommodate the tank geometry which can be different for every tank car; it should provide accurate measurement when there is only a small amount of commodity in the bottom of the tank car; and it should operate under extreme environmental conditions.

It would therefore be advantageous if there were a device and/or process that would address some of the issues identified above.

### SUMMARY OF THE INVENTION

The invention disclosed herein relates to particular devices and methods for measuring commodity volume in a rail tank car. In accordance with one aspect of the present invention, the device can comprise a configuration so as to enable it to be installed permanently/semi-permanently on a rail tank car and to minimize interference with other fittings and valves.

In accordance with an embodiment, a measurement device for a rail tanker car can comprise a stem for allowing tool access for mounting and removal of the device, a wireless connection to a gateway system for remote monitoring of rail car inventory and controlling various product settings, a serviceable enclosure, a user interface, and an antenna port.

In accordance with another embodiment, the device of the present invention can comprise a stem, a low energy wireless connection to a gateway system for remote monitoring of rail car inventory and controlling various product settings, a serviceable enclosure that can further include a hinge for enabling battery changes (in case of electronics failure it may be disconnected at the stem and new electronics may be replaced without breaking the primary seal of the rail car), a top facing user interface which displays volume and displacement (the interface can also use a single button to reduce tampering and simplify its use), an overall geometry that may not interfere with the operation or mounting of other fittings, a heavy duty metal enclosure with integrated shear point which may protect the primary seal and intrinsically safe electronics during a catastrophic shearing force incident, a single piece heatsink design that can ensure acceptable failure temperatures which can provide intrinsic safety during high power failure modes of the radar circuitry but can allow radio frequency traces and sensitive components to be minimally affected by the metallic structure around it, and an antenna port geometry which can connect to a common 4 ⅛″ and 3 ¼″ flange that may originally have been used for magnetic float gauges. In a further embodiment the device may also be battery powered.

In another aspect, the device of the present invention can include an antenna for use on a rail car fittings plate that comprises a horn antenna which may be integrated into a single flange, an internally plated horn that can reduce RF losses, a radome, and a waveguide neck.

In an alternate embodiment the device of the present invention can include an antenna comprising a robust horn antenna which may be integrated into a single flange and made of high strength stainless or carbon steel, for example using high strength metals to maintain critical seals on the tanker car's primary closure can increase safety. An internally copper plated horn may also be included for reducing RF losses while using high strength metals in addition to a flat to convex radome which uses the lensing effect with organic thermoplastics, such as for example, PEEK for improving energy transfer into the tanker car, narrow the antenna Beamwidth, and can ensure chemical compatibility with many commodities found in the rail industry. The radome may be minimized in thickness so as to reduce radio frequency losses through itself, while strong enough to meet standard operating pressures and temperatures within the rail car, such as 85 psi @ 90 deg C., for example. A radome surrounded by a conductive seal and mated to the rail car's primary closure can improve the waveguide continuity which can reduce side lobes and provide an environmental seal into the horn antenna cavity. A waveguide neck which may comprise a thin configuration and use a small unthreaded feed pin sealed with conductive epoxy which may then be pre-loaded with a metal bracket, for improving pressure holding capacity and allowing access to primary mounting bolts with 3 ¼″ flanges. This minimized design may also allow for the product stem to thread onto the outside of the waveguide neck for simplified product assembly.

In another aspect, the present invention provides a process for measuring commodity volume that can comprise an N-point calibration using a Coriolis meter, a first stage coarse resolution peak detection and a second stage for enhancing the resolution around the peak which can improve system resolution and reduce the required system memory, and measurement of the residual commodity.

In another embodiment, the present invention includes a set of signal processing tools comprising an N-point calibration using a Coriolis meter which can enhance the accuracy of strapping tables and ultimately the accuracy of the systems volume measurement. A first stage coarse resolution peak detection and then a second stage which can enhance the resolution around the peak and can improve system resolution and reduce the required system memory. A process that can reduce ambiguity when measuring the residual commodity (commonly known as heel) at the bottom of a horizontal cylindrical container. This can be achieved through shape detection around the measured peak when the measurement is within the ambiguous range. An additional method for low dielectric constants can examine the received power in reference to a calibration point.

### BRIEF DESCRIPTION OF THE DRAWINGS

The invention disclosed herein relates to particular devices and methods for measuring commodity volume in a rail tank car.

When describing the present invention, any term or expression not expressly defined herein shall have its commonly accepted definition understood by those skilled in the art. To the extent that the following description is of a specific embodiment or a particular use of the invention, it is intended to be illustrative only, and not limiting of the invention, which should be given the broadest interpretation consistent with the description as a whole.

The subject matter which is regarded as the invention is particularly pointed out and distinctly claimed in the concluding portion of the specification. The invention, however, may best be understood by reference to the following detailed description of various embodiments and accompanying drawings in which:

FIG. 1 depicts an embodiment of the device of the present invention mounted in a typical location on a rail tanker car;

FIG. 2 is a front perspective view of an embodiment of the device of the present invention;

FIG. 3 is a flow chart depicting the internal architecture of an embodiment of the device of the present invention;

FIG. 4 is an exploded and cross sectional view of an embodiment of an antenna flange of the present invention;

FIG. 5 illustrates an example of a signal returned when residual commodity is at the bottom of a tanker car;

FIG. 6 is a flow chart depicting a method for determining level and residual commodity in a tanker car; and

FIG. 7 is a flow chart depicting an alternate method for determining level and residual commodity in a tanker car.

### DESCRIPTION OF THE PREFERRED EMBODIMENT

The invention disclosed herein relates to particular devices and methods for measuring commodity volume in a rail tank car. In accordance with one aspect of the present invention, the device can comprise a configuration so as to enable it to be installed permanently/semi-permanently on a rail tank car and to minimize interference with other fittings and valves.

The present invention can provide a non-contact radar means for a rail tank car. The device of the present invention may be semi-permanently or permanently mounted to a gauge port on the tank car and may also act as a convenient drop in replacement for the older mechanical floats. Power may be supplied by internal batteries, for example, and use a push button operation, or similarly functioning means may be used to get level or volume from the tank car.

The present invention can collect range information. In accordance with an embodiment, the present invention can incorporate hybrid Stepped Frequency Continuous Wave (SFCW) and Continuous Wave (CW) techniques to collect range information, and antenna performance can be optimized for the primary closure of a rail tank car. In additional embodiments, the range information may be collected by alternate techniques.

Upon collection of range information further post-processing can be used to enhance the measurement of the heel (i.e. small amount of commodity at the bottom of the tank car), and reject piping, such as eduction pipe and thermowell in the tank car. In accordance with the present invention, commodity can include any commodity typically transported by a rail car, including but not limited to fuel oils and asphalt, bitumen, petroleum products, food grade oils, chemicals, ethanol, liquid fertilizers, molten-sulfur, clay surry, caustic soda, corn syrup, etc., or any solid materials, including grains, etc.

Industry standard gage tables may also be implemented to enhance measurement accuracy for each specific rail car.

General operation of the device may be performed with a simplified user interface, while more advanced settings can be set wirelessly to prevent/reduce tampering. Other operational modes of the invention can include pushbutton level, or functionally similar measurement mode, continuous monitoring mode, and autonomous mode.

Pushbutton measurement level may display the level and/or volume in the tank upon the pushing of a button or similar means, for example. Continuous monitoring mode can allow for the monitoring of the emptying and filling of the tank car while providing visual, auditory, and/or wireless alarms for pre-set levels or volumes. An adaptive algorithm based on flow rate estimation can be used to improve battery life during continuous monitoring mode as well. In autonomous mode, the device can “wake up” occasionally, during transport or otherwise, and record information such as level, temperature, and vibration. This information may then be recorded to detect leakage, physical changes in the commodity such as expansion and contraction, and create a history of vibration and temperature exposure for the commodity and/or device.

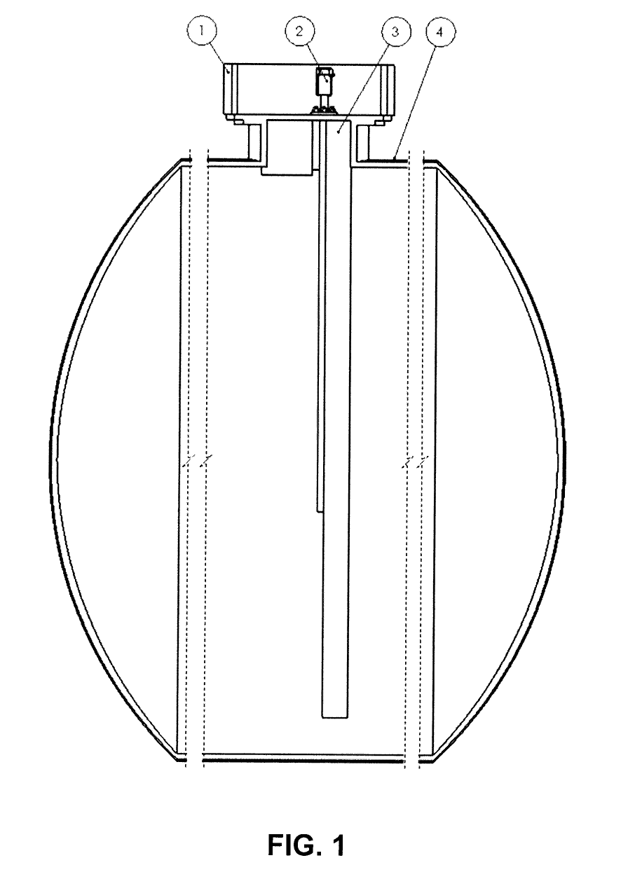

Referring now to the drawings, FIG. 1 depicts a typical mounting location for a device 2 of the present invention on a rail tanker car 4. The device 2 can be located in the crash cage 1 of the rail car where it can be further protected from environmental conditions and impacts during catastrophic events. Additionally, the device 2 may be designed so as to comprise an overall size, shape, and mounting location so as to allow other fittings, such as, for example, valves and pressure relieve devices, to remain unobstructed. The mounting geometry can be designed for existing magnetic float gage ports using, for example, 4-⅛″ and 3-¼″, between hole center flanges. Using these mounting ports may remove the need to perform additional machining on the fittings plate and to prove out a new primary closure seal design. However, the port may be small which can limit antenna performance but can be addressed by the antenna design, as will be discussed further below.

Typical rail tank cars can also include several forms of piping 3 which can affect the accuracy of a wireless level measurement system. In accordance with one aspect, the present invention can reject piping 3, by ensuring the antenna beam width and mounting location are sufficient to reduce detection.

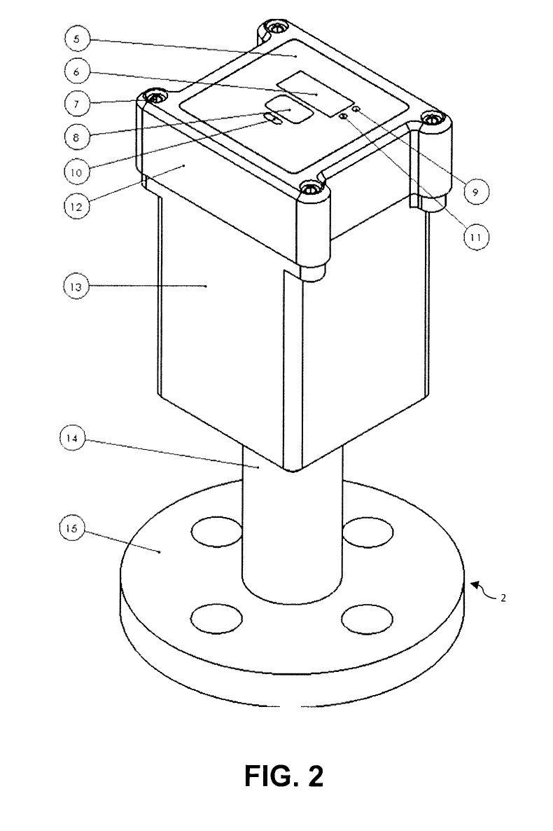

Referring now to FIG. 2, depicted therein is an isometric view of an embodiment of the device 2 of the present invention. The user interface can consist of several elements that face vertically towards the user. User input can be supplied through a button 8 located near the center of the membrane 5. However, in alternate embodiments, one or more functionally similar means may be used in place of or in conjunction with the button 8. An LCD 6 is also shown, operable for providing one or more of volume, level, and a minimalistic menu to the user. The limited interface can act to minimize tampering and can enable owners/users to control how the device 2 may be used and setup. Communication through low power wireless can enable more complex and important settings to be accessed through, for example, handheld device or cellular gateway with a web interface. An IRDA 10 port can also be integrated so as to modify more complex device settings, for example. LEDs, for example, may be used for indicating battery low 9 and processing activity 11 to the user. However, in alternate embodiments, one or more functionally similar means may be used.

As depicted, the device 2 can consist of several major components, including a case top 12, a case bottom 13, a stem 14, and a flange mounted antenna 15. Each of the major components may comprise a structurally suitable material, such as metal or a substantially metallic material, with the exception of the case top 12, which may comprise a material, such as plastic, or a substantially plastic material, suitable for enabling wireless communications with the internal antenna. As depicted, a clevis pin between the case top 12 and case bottom 13 forms a hinge which can enable the user to change a battery pack of the device 2. Security fasteners 7 may also be used to reduce tampering with the device 2. It should be appreciated that, in various alternate embodiments, any number or style of fasteners, or hinge styles may be used. The stem 14 can act to enable tool access to the flange mounted antenna 15, while providing thermal separation from the tank. This separation can enable a wider range of process temperatures to be used by increased distance from the heat source and convection currents to flow under the electronics. If the electronics fail in service, the connection point between the stem 14 and case bottom 13 can be disconnected, while maintaining a primary seal to the rail car. This can reduce the cost and time needed to replace the device 2. The stem 14 can also provide a notched shear point to protect the primary closure's seal during events, such as, a catastrophic shearing force incident, for example.

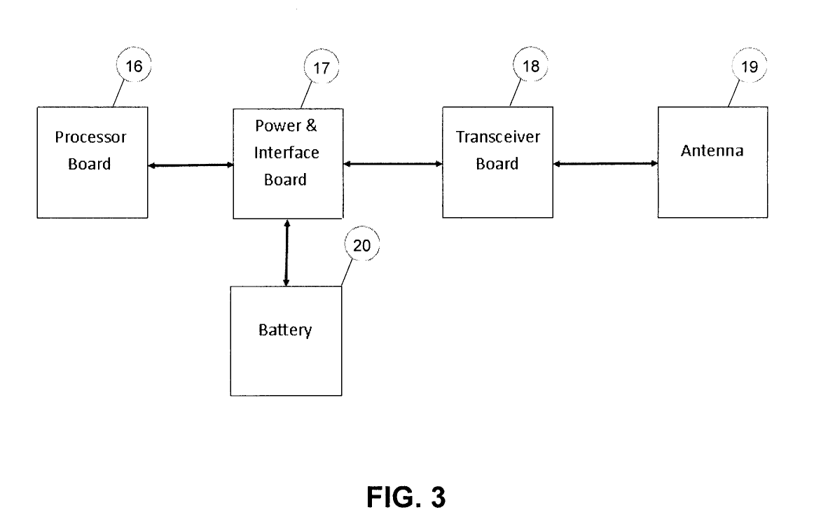

Referring now to FIG. 3, a block diagram of the internal architecture of the device is depicted. Processing, control, and user interface functions can be handled in the processor board 16. The power and interface board 17 can provide an isolated connection between the processor board 16 and transceiver board 18. The interface board 17 can also handle protection to meet intrinsic safety requirements between the boards and from the battery 20. The transceiver board 18 can comprise RF circuitry, amplifiers, filters, and converters required to modulate and capture the radar signal. The transceiver board 18 can also use a heatsink to improve intrinsic safety fault temperatures while reducing its impact on the RF performance of the traces and components. This board can then be connected to the antenna 19 which may have a clear view into the tanker car for level measurement.

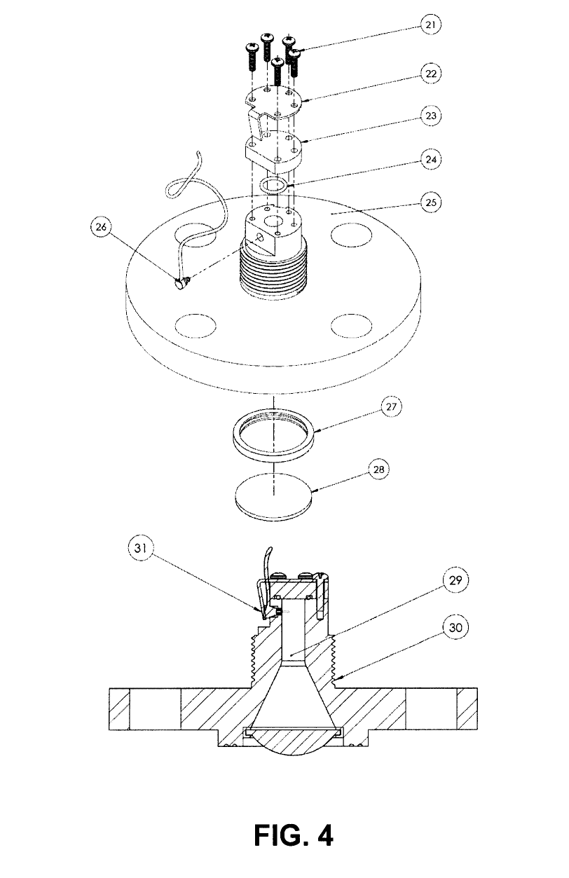

FIG. 4 shows exploded and cross sectional view of an embodiment of an antenna flange. Fasteners 21 can be used to mount the pin holder 22, and seal the end cap 23 against the waveguide of the antenna 25. A seal 24 can function to prevent leakage of the pressurized tanker car if the radome 28 were to fail. An endcap 23 can function to improve the electrical connection and performance, and may comprise any suitable material, such as copper plated steel, for example. A feed pin 26, for example, can be conductive epoxied into the mating hole and can complete the dipole fed waveguide. During high temperature and pressure failure the pin holder 22 can apply a preloaded force 31 to the feed pin 26 so as to prevent and/or hinder leakage. Such a design can also save space, which can allow for an external thread 30 around the waveguide to ease the assembly of the device, and can allow tool access, for example, for the 3-¼″ between hole center bolt pattern.

The flanged antenna 25 may be of any suitable high strength material with low conductivity, such as, for example, steel or stainless steel, etc. Using high strength materials can also improve the safety of the primary closure and may also be required by the rail industry. To minimize RF loss through the horn 29 a process may be used to internally copper plate it. Intermediate layers of plating, such as nickel, for example, can be used which can improve the adhesion of the copper plating with minimal impact on RF performance.

To further improve safety and corrosion resistance an organic thermoplastic (e.g. PEEK) may be used to form the radome 28. The radome 28 can be flat to convex in shape and paired with a chemical resistant thermoplastic which can provide a lensing effect for improving energy transfer into the tanker car, reducing antenna side lobes, narrowing the antenna beam width, and can help to ensure chemical compatibility with many of the different commodities transported in the rail industry. The strength of the organic thermoplastic can also allow it to hold higher pressures at high temperature and use less thickness to minimize RF losses through itself. The radome 28 may additionally be surrounded by a conductive gasket for providing an environmental seal to the inside of the horn 29 and for improving waveguide continuity when attached to the rail car. Doing so can help to reduce RF reflections at the antenna aperture connection to the rail car and can reduce the antenna side lobes.

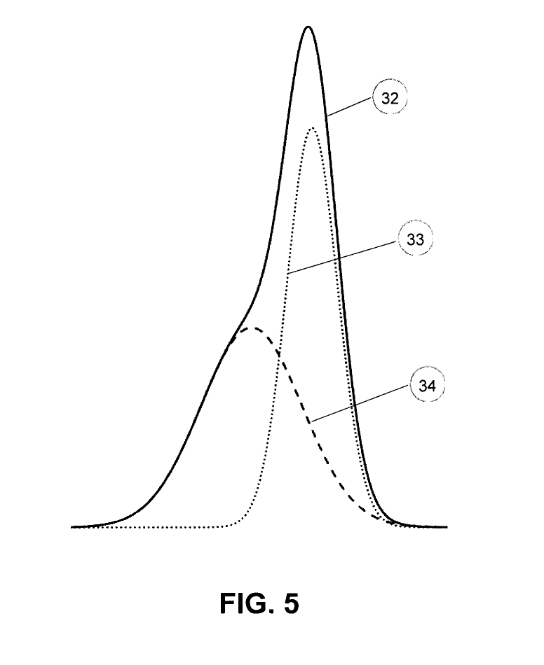

Referring now to FIG. 5, a typical signal returned is shown when residual commodity (heel) is in the bottom of the tanker car. Under normal conditions with a flat heel, the peak of the received signal 32 can follow the commodity with reasonable accuracy until it hits an ambiguous range. This ambiguous range can be created by a combination of the tank car 33 and commodity 34 reflections. This can create a distinct received signal 32 shape that can be identified and used to remove the ambiguity.

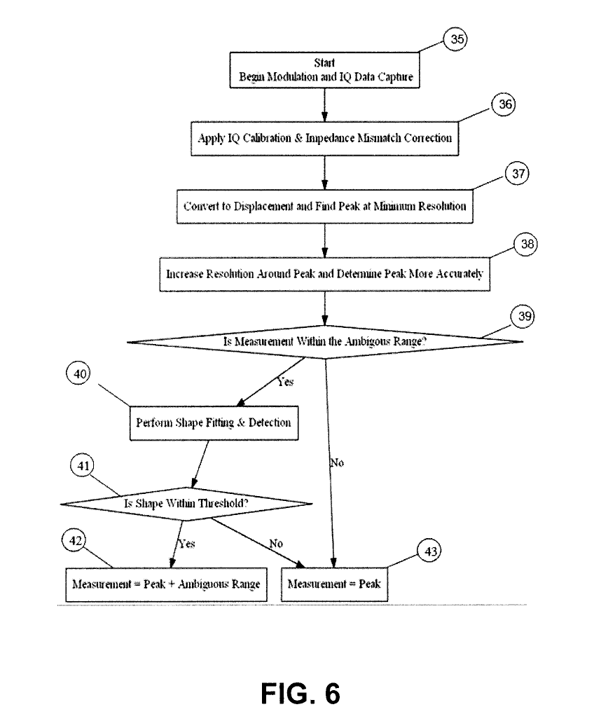

FIG. 6 illustrates a method for determining level and residual commodity in the tanker car. The SFCW modulation can be started, and data, such as IQ data, can be captured 35. Then calibrations to remove IQ imbalances, impedance mismatches, temperature calibrations can be applied to the signal 36. The signal can then converted to the time domain and peak detection can be used to find the approximate range 37. The signal resolution can then be increased around the peak of interest to obtain a higher resolution measurement, while reducing the signal processing time and RAM that may be required 38. Depending on the range that the measurement lands in, it may be ambiguous and require further processing 39. If the peak falls outside of the ambiguous range, then the range may require no further processing. If the peak is within the ambiguous range, then the shape may need to be ratiometrically compared to a shape collected from calibration on an empty tank 41. If the shape is within a threshold, then the ambiguous range can be added to the range measurement 42. However, if the shape is outside the threshold, then no further processing may be required.

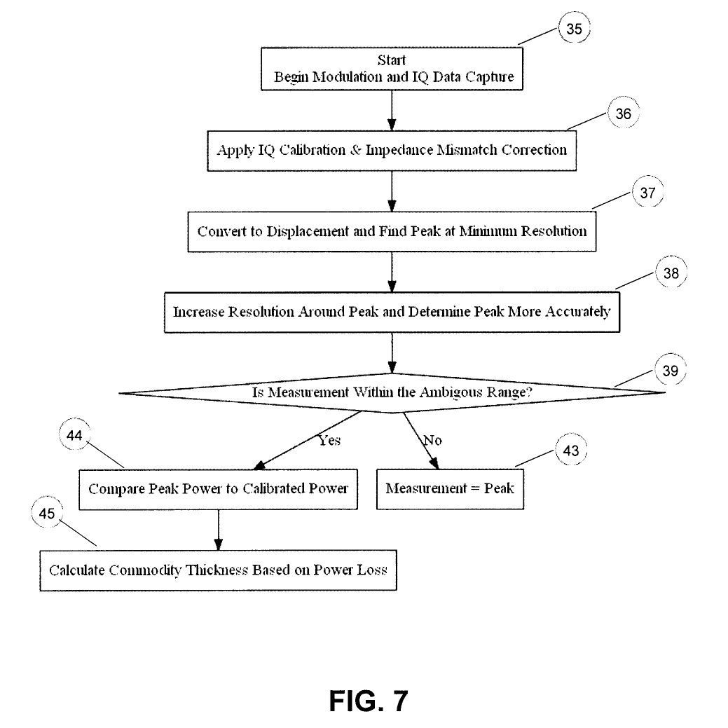

FIG. 7 depicts another method for determining the level and residual commodity in the tanker car. The first steps, from 35 to 39, are the same as depicted by FIG. 6, but the method to detect residual commodity is different.

This method can compare the measured power response of the empty tank to the current measurement 44. The difference of the two powers, and dielectric constant and tan delta of the commodity can provide a model to estimate the thickness of the residual commodity. Ultimately, the residual commodity thickness can be determined by the power loss through the material. While the method depicted by FIG. 6 can lend itself to materials with higher dielectric constants, as they may have a higher reflected power which can change the shape of the detect peak more easily, the method depicted by FIG. 7 can lend itself to materials with lower dielectric constants because more energy can make it into the commodity which can give greater power loss relative to an empty tank.

Various embodiments of the invention's shape and functionality are possible. In preferred embodiments, the general goal can be to adapt the device so as to be installed permanently/semi-permanently on a rail tank car, while minimizing interference with other fittings and valves. Additionally, different power sources may be used for enabling the operation of the device, such as, one or more of solar power, external batteries, vehicle power, for example. Measuring the residual commodity within the tank car can be handled multiple ways for creating the same or similar effect. This can be done by creating minor variations in the modeling and the orders in which the steps are executed.

### REFERENCE NUMERALS IN DRAWINGS

| | | | |
|---|---|---|---|
| 1 | Crash Cage | 2 | Device |
| 3 | Piping | 4 | Tanker Car |
| 5 | Membrane | 6 | LCD |
| 7 | Security Fastener | 8 | Button |
| 9 | Battery Low LED | 10 | IRDA |
| 11 | Active LED | 12 | Case Top |
| 13 | Case Bottom | 14 | Stem |
| 15 | Flange Antenna | 16 | Processor Board |
| 17 | Power & Interface Board | 18 | Transceiver Board |
| 19 | Flanged Antenna | 20 | Battery |
| 21 | Fastener | 22 | Pin Holder |
| 23 | Waveguide Cap | 24 | Seal |
| 25 | Flanged Antenna | 26 | Feed Pin |
| 27 | Conductive Gasket | 28 | Radome |
| 29 | Horn | 30 | External Threading |
| 31 | Preloaded Feed Pin | 32 | Received Signal |
| 33 | Tank Car Element | 34 | Commodity Element |
| 35 | Data capture and Modulation | 36 | Calibration and Correction |
| 37 | Coarse Peak Search | 38 | Fine Peak Search |
| 39 | Within Ambiguous range | 40 | Shape Detection |
| 41 | Threshold Detection | 42 | Calculate Ambiguous Range |
| 43 | Calculate Range | 44 | Power Comparison |
| 45 | Power loss Range calculation | | |

The above-described embodiments of the invention are intended to be examples only. Alterations, modifications and variations can be effected to the particular embodiments by those of skill in the art without departing from the scope of the invention.

What is claimed is:

1. A measurement device for measuring commodity volume in a rail or tank car or other container or enclosure comprising:
a stem, for allowing tool access for mounting and removal of the device;
a wireless connection to a gateway system for remote monitoring of rail car inventory and controlling various product settings;
a serviceable enclosure;
a user interface;
an energy source; and
an antenna.

2. An antenna for use with a device for measuring commodity in a rail tanker car comprising:
a horn antenna, integrated into a single flange;
an internally plated horn to reduce RF losses;
a radome; and
a waveguide neck.

3. A process for measuring commodity volume comprising:
an N-point calibration;
a first stage coarse resolution peak detection and a second stage, for enhancing the resolution around the peak to improve system resolution and reduce the required system memory; and
measuring the residual commodity.

4. Use of the device of claim 1, for measuring commodity volume in a rail or tank car.
